(19) United States
(12) Patent Application Publication
(10) Pub. No.: US 2025/0199475 A1
(43) Pub. Date: Jun. 19, 2025

(54) DEVICE FOR SEPARATING WOUND IN BALANCE SPRINGS AFTER AN EXPANSION CYCLE, AND METHOD FOR MANUFACTURING A BALANCE SPRING COMPRISING A SEPARATION STEP CARRIED OUT BY SUCH A DEVICE

(71) Applicant: Nivarox-FAR S.A., Le Locle (CH)

(72) Inventors: Lionel MICHELET, Sainte-Croix (CH); Pierre CHAMPEMONT, Vennes (FR); Daniel MALLET, Le Bélieu (FR)

(73) Assignee: Nivarox-FAR S.A., Le Locle (CH)

(21) Appl. No.: 18/816,189

(22) Filed: Aug. 27, 2024

(30) Foreign Application Priority Data
Dec. 19, 2023 (EP) 23218286.5

(51) Int. Cl. G04B 17/06; G04B 17/22

(52) U.S. Cl. CPC G04B 17/066; G04B 17/227

(57) ABSTRACT

A device (100) for separating an assembly (10) of balance springs (12) which have been wound in and have undergone an expansion cycle, the device (100) including: a support (110) having notches (113) intended to receive the inner strands (13) of the wound in balance springs (12) making up the assembly (10), a vibrating table (120) movable along two different axes which extend in the same plane, defining a vibration plane (P1), the vibrating table (120) being configured to cause said support (110) to vibrate in a plane parallel to the vibration plane (P1). Also a method for manufacturing a balance spring.

### CROSS REFERENCE TO RELATED APPLICATION

This application claims priority to European Patent Application No. 23218286.5 filed Dec. 19, 2023, the entire contents of which are incorporated herein by reference.

### TECHNICAL FIELD OF THE INVENTION

The invention relates to a method for manufacturing a balance spring intended to equip a balance of a horological movement, as well as a method for manufacturing such a balance spring.

The invention relates to a device for separating balance springs to facilitate the step of separating the balance springs after heat treatment in a method for manufacturing a balance spring.

The invention further relates to a method for manufacturing a balance spring intended to equip a balance of a horological movement.

### Technological Background

The manufacture of balance springs for horology is subject to restrictions that often appear irreconcilable at first sight:
the need to obtain a high yield strength;
an ease of manufacture, particularly of wire drawing and rolling operations;
an excellent fatigue strength;
stable performance levels over time;
small cross-sections.

The production of balance springs is furthermore focused on concern for thermal compensation, in order to guarantee consistent chronometric performance levels. This requires obtaining a thermoelastic coefficient that is close to zero. Balance springs with limited sensitivity to magnetic fields are also sought.

Any improvement on at least one of these points, and in particular on the limited sensitivity to magnetic fields, thermal compensation, and the ease of manufacture, particularly drawing, wire drawing and rolling operations, thus represents significant progress.

In the manufacturing cycle of a balance spring, the winding in operation consists of winding a plurality of rolled wires in a barrel by means of a winding star or spindle so as to form an assembly, or plate, made up of a plurality of balance springs wound in the same plane.

The assembly typically comprises between 3 and 6 spirally-wound wires.

The various wound in balance springs are then fixed by means of an expansion cycle, typically a heat treatment, to give them a final Archimedean spiral shape with a regular pitch, to obtain the desired thermoelastic coefficient (TEC) and to increase hardness. The next step involves separating the various interlocking wound in balance springs.

This step can become particularly difficult with compensating balance springs, and even more so with titanium alloy balance springs, as the presence of titanium in the alloy increases the frictional force between the various balance springs.

As a result, there is a need to improve this step of separating the balance springs after winding in and heat treatment, in particular to minimise the reject rate during the manufacture of such balance springs, and in particular compensating balance springs.

### SUMMARY OF THE INVENTION

In this context, the invention proposes a device for separating an assembly of balance springs which have been wound in and have undergone an expansion cycle, the device comprising:
a support comprising notches intended to receive the inner strands of the wound in balance springs making up the assembly;
a vibrating table movable along two different axes which extend in the same plane, defining a vibration plane P1, the vibrating table being configured to cause said support to vibrate in a plane parallel to the vibration plane P1.

Such a device facilitates the separation of assemblies of a plurality of wound in springs after heat treatment. Such a device is particularly effective on compensating balance springs, and in particular balance springs made from a titanium alloy.

Preferably the two vibration axes are orthogonal to each other.

Vibration in two directions in the same plane allows in particular vibratory movements tangential to the coils of the balance springs to be generated.

Such a vibration elastically deforms the individual coils of the balance springs by matching the shape of the coils, starting from the centre of the assembly and propagating towards the outermost coils of the balance springs.

In addition to the features mentioned in the preceding paragraph, the device according to the invention can have one or more complementary features from among the following, considered either on an individual basis or according to any combination technically possible:
the vibrating table vibrates in a circular translational motion;
the support comprises a body integral with the vibrating table and a spindle integral with the body and extending perpendicularly to the body and to the vibration plane P1 of said vibrating table;
the notches are formed at the free end of the spindle;
the free end of the spindle is conical in shape;
the device comprises an air ejector for ejecting the separated balance springs when the vibrating table is caused to vibrate;
the device comprises a collection tray to receive the ejected balance springs;
the device comprises a removable cover configured to at least partially cover the free end of the spindle;
the removable cover is movable between a closed position preventing the balance springs from being removed from the support and an open position allowing the assembly of wound in balance springs to be inserted onto the support and allowing the balance springs separated from the support to be removed;
the removable cover can be moved translatably along an axis perpendicular to the vibration plane P1 of the vibrating table;
the removable cover comprises a recess configured to receive the free end of the spindle when it is in the closed position;
the device comprises a motor configured to cause the vibrating table to vibrate at a frequency of between 1,000 Hz and 12,000 Hz, preferably between 4,000 Hz and 8,000 Hz;
the motor is an air motor or a piezoelectric motor.

Another aspect of the invention relates to a method for manufacturing a balance spring intended to equip a balance of a horological movement.

According to the invention, the manufacturing method comprises in particular a step of separating an assembly of balance springs that have been wound in and have undergone an expansion cycle, which step is carried out by implementing the separation device according to the invention.

Preferably, the manufacturing method comprises, prior to the separation step, a winding in step consisting of winding a plurality of rolled wires in a barrel by means of a winding star so as to form the assembly of wound in balance springs.

Preferably, the manufacturing method comprises, after the winding in step, an expansion step relieving the stresses in the assembly of wound in balance springs of the assembly.

Preferably, the balance spring is a compensating spring.

Preferably, the balance spring is made from a niobium and titanium alloy.

### BRIEF DESCRIPTION OF THE FIGURES

The purposes, advantages and features of the present invention will be better understood upon reading the detailed description given below with reference to the following figures:

FIG. 1 diagrammatically shows an example embodiment of a device for separating an assembly of wound in balance springs which have undergone an expansion cycle according to the invention;

FIG. 2 diagrammatically shows the device according to the invention illustrated in FIG. 1 during a step of closing and causing an assembly of wound in balance springs to vibrate;

FIG. 3 diagrammatically shows the device according to the invention illustrated in FIG. 1 during a step of ejecting the separated balance springs after vibration;

FIG. 4 shows a top view of the vibrating table and of the support of the device illustrated in FIG. 1;

FIG. 5 shows a block diagram illustrating the main steps of a method for manufacturing a balance spring intended to equip a balance of a horological movement according to the invention;

FIG. 6 diagrammatically illustrates a barrel containing an assembly of a plurality of wound in balance springs fixed by means of an expansion cycle;

FIG. 7 diagrammatically illustrates a balance spring in its final state, which balance spring is intended to equip a balance of a horological movement.

### DETAILED DESCRIPTION OF THE INVENTION

During the manufacturing cycle of a balance spring, the winding in operation consists of winding a plurality of rolled wires into a barrel 2 (illustrated in FIG. 6) by means of a star piece, or winding spindle, so as to form an assembly, or plate, composed of a plurality of wound in wires which are positioned and wound in the same plane. From this step onwards, the wound in wires are considered to be wound in balance springs since the shape is definitive and imposed by the barrel 2.

The various wound in springs making up the assembly 10 are then fixed by means of an expansion cycle, typically a heat treatment, to give them the final shape of an Archimedes spiral with a regular pitch.

FIG. 6 diagrammatically illustrates an assembly 10 of a plurality of wound in balance springs 12 which are fixed by means of an expansion cycle.

FIG. 7 diagrammatically illustrates a balance spring 12 in its final state, which balance spring is intended to equip a balance of a horological movement.

Typically, the assembly 10 is composed of 3 to 6 balance springs 12. In the example shown, the assembly 10 comprises 4 balance springs 12.

The next step involves separating the various wound in and thermally fixed balance springs 12 of the assembly 10.

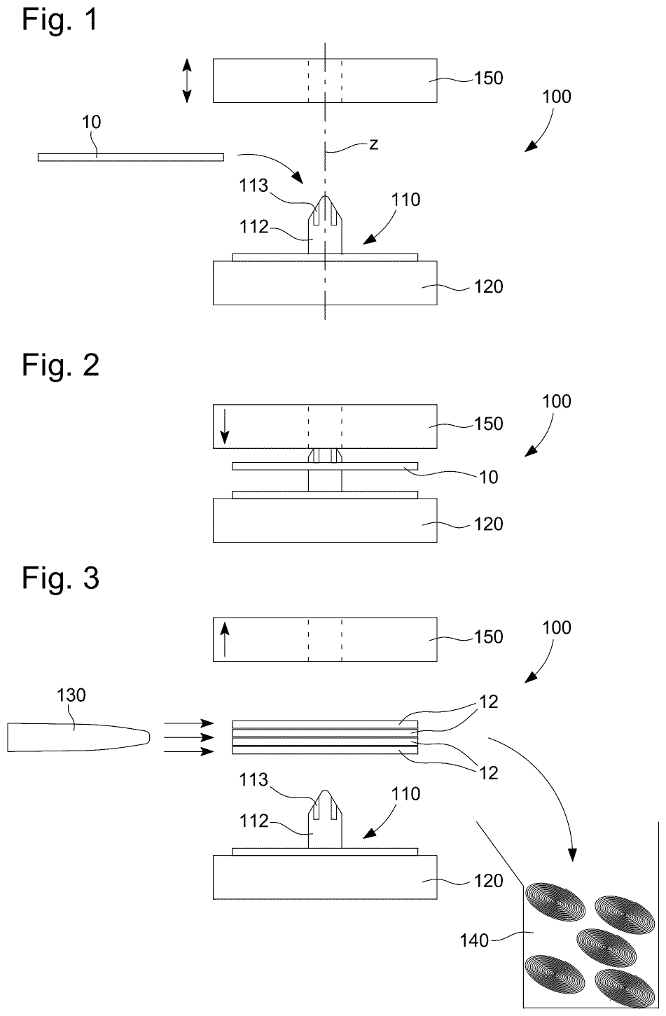

FIG. 1 diagrammatically shows an example embodiment of a device 100 for separating an assembly 10 consisting of a plurality of wound in, thermally fixed balance springs 12.

The device 100 is described with reference to FIGS. 1 to 4, which diagrammatically illustrate different states of the device 100 during the operation of separating the balance springs 12.

The device 100 comprises a support 110 configured to receive and hold the assembly 10 during the separation operation.

More particularly, the support 110 comprises a base or a body 111 and a spindle 112 extending perpendicularly to the general plane formed by the body 111.

The spindle 112 has a plurality of notches 113 at its free end. Preferably, the number of notches is greater than or equal to the number of wound in coil springs making up the assembly 10. Thus, in the illustrated example embodiment, the spindle 112 comprises four notches 113 evenly distributed around the circumference of the spindle 112.

Preferably, the free end at least partially bearing the notches 113 has a conical profile so as to facilitate positioning of the assembly 10 or removal of the individual separated balance springs 12.

The notches 113 are configured to receive the inner strands 13 of the wound in balance springs 12 and to hold the assembly 10 at a certain distance from the body 111. Thus, the various wound in balance springs 12 of the assembly 10 are held in the device 100 solely by the inner strands forming the inner ends of the wound in balance springs 12, the various coils of the wound in balance springs 12 being suspended above the body 111 of the support 110.

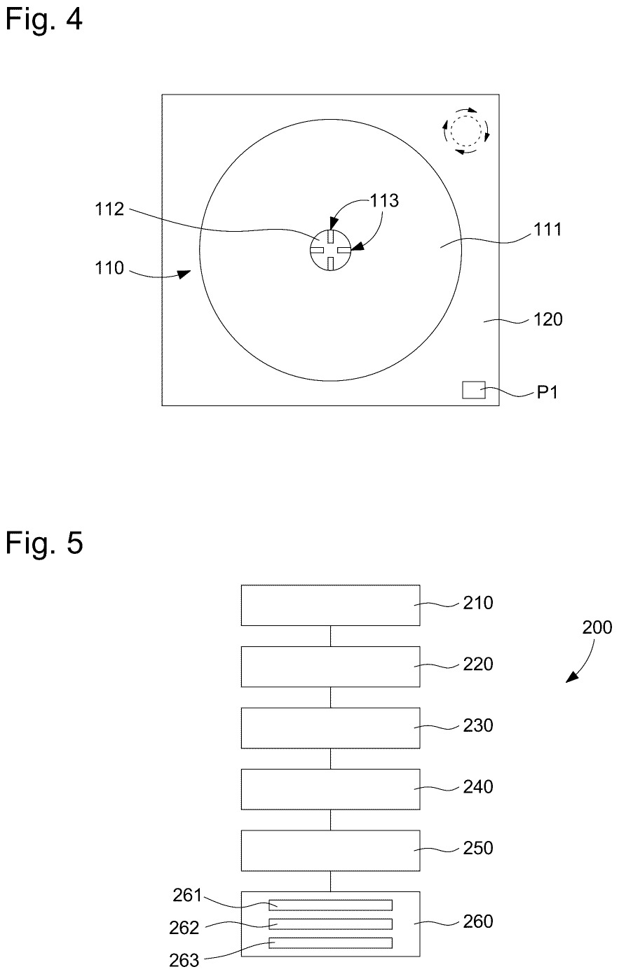

The device 100 comprises a vibrating table 120 vibrating along two different axes which extend in the same plane, defining a vibration plane P1, illustrated in FIG. 4.

Preferably the two vibration axes are orthogonal to each other.

The vibrating table 120 moves in circular translation in the vibration plane P1, as shown in FIG. 4.

A circular translational movement is defined as a planar movement in which all of the points on the vibrating table 120 have trajectories which are circles of the same radius but with different centres.

The vibrating table 120 is caused to vibrate by being mechanically driven by a motor (not shown). For example, the motor is a pneumatic motor or a piezoelectric motor.

The motor causes the vibrating table 120 to vibrate at a frequency of between 1,000 Hz and 12,000 Hz, preferably between 4,000 Hz and 8,000 Hz, for example at 6,000 Hz.

The amplitude, frequency and vibration power of the vibrating table 120 can be modified via a man-machine interface (not shown).

The vibrating table 120 is integral with the body 111 such that the support 110 is also caused to vibrate in a plane parallel to the vibration plane P1.

The device 100 further comprises a removable cover 150, or lid, configured to at least partially cover the free end of the spindle 112 to limit the axial movement of the assembly 10 and the separated balance springs 12, along the longitudinal axis z of the spindle 112, when the support 110 is caused to vibrate.

The removable cover 150 comprises an opening or a recessed area set back relative to its lower face, i.e. its face facing the vibrating table 120. This opening or recessed area forms a recess 151 configured to receive the free end of the spindle 112 when the removable cover 150 is in the closed position.

The removable cover 150 is movable between a closed position limiting the movement of the balance springs along the z axis of the spindle 112 and preventing the balance springs 12 from being removed from the spindle 112 of the support 110, and an open position allowing the assembly 10 of wound in balance springs to be inserted onto the support 110 and also allowing the balance springs 12 to be removed once separated.

Preferably, the removable cover 150 can be moved translatably along an axis perpendicular to the vibration plane P1 of the vibrating table 120. Preferably, the translation axis of the removable cover 150 coincides with the longitudinal axis z of the spindle 112.

The device 100 further comprises an ejector for removing the separated balance springs 12 from the support 110 in order to prepare for a new cycle for separating an assembly 10. Preferably, the ejector 130 is an air ejector, for example a compressed air ejector.

The device 100 further comprises a collection tray 140 for recovering and collecting the various ejected balance springs 12.

The invention further relates to a method 200 for manufacturing a balance spring intended to equip a balance of a horological movement, which method comprises at least one step 260 of separating the wound in, thermally fixed balance springs, which step is implemented by the device 100 according to the invention.

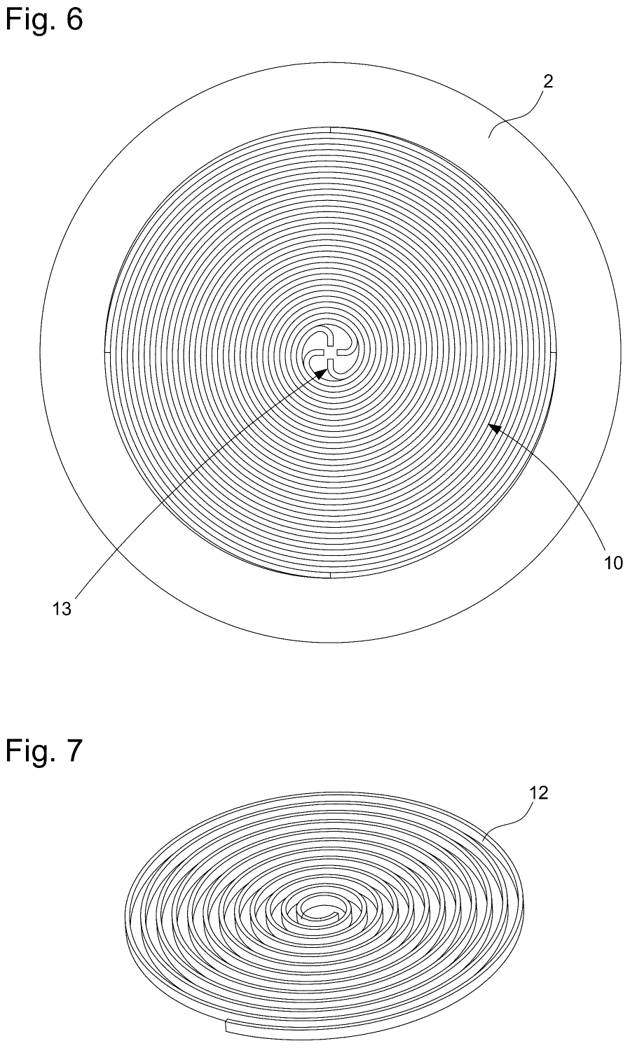

The main steps of the manufacturing method 200 are given with reference to FIG. 5.

The manufacturing method 200 comprises the following successive steps:
a step 210 of producing a blank made of an alloy, preferably a compensating alloy, and more particularly of a titanium alloy, preferably an alloy comprising niobium and titanium,
a step 220 of applying precipitating coupled deformation-heat treatment sequences to said alloy, which sequences comprise the application of deformation alternating with heat treatment, until a desired microstructure is obtained,
a wire drawing step 230 carried out until a wire with a round cross-section is obtained, and rolling to produce a rectangular profile compatible with the inlet cross-section of a drawing spindle or star piece,
a winding in step 240 consisting of winding a plurality of rolled wires in a barrel by means of the winding spindle, or star piece, so as to form the assembly 10 of wound in balance springs 12, the various balance springs 12 being wound in the same plane,
an expansion step 250 relieving the stresses in the assembly 10 of wound in balance springs 12 in order to fix the final Archimedean spiral shape of the balance springs 12 by means of an expansion cycle.

The manufacturing method 200 further comprises the step 260 of separating the wound in balance springs that were thermally fixed during step 250. This separation step 260 is implemented by the device 100 in the following manner:
in a first sub-step 261 illustrated more particularly in FIG. 1, the assembly 10, formed by a plurality of wound in, thermally fixed balance springs 12, is positioned on the spindle 112 of the support 110, so as to position the inner strands 13 in the notches 113 of the spindle 112; the assembly 10 is then suspended in the device 100, held solely by the inner strands 13 of the wound in balance springs 12;
in a second sub-step 262 illustrated more particularly in FIG. 2, the removable cover 150 is lowered to be positioned in the closed position so as to prevent loss of the assembly 10 mounted on the spindle 112; the support 110 is caused to vibrate by the vibrating table 120 so as to generate a circular translational movement in a plane parallel to the plane of the balance springs 12; the balance springs 12 are then separated from each other so that they no longer lie in the same plane;
in a third sub-step 263 illustrated more particularly in FIG. 3, the removable cover 150 is raised to be positioned in the open position and a flow of air is generated by the air ejector 130 to eject the separated balance springs 12; the final balance springs 12 are collected in the collection tray 140.

1. A device for separating an assembly of balance springs which have been wound in and have undergone an expansion cycle, the device comprising:
a support comprising notches intended to receive the inner strands of the wound in balance springs making up the assembly; and
a vibrating table movable along two different axes which extend in the same plane, defining a vibration plane, the vibrating table being configured to cause said support to vibrate in a plane parallel to the vibration plane.

2. The device according to claim 1, wherein said two vibration axes are orthogonal.

3. The device according to claim 1, wherein said vibrating table vibrates in a circular translational motion.

4. The device according to claim 1, wherein said support comprises a body integral with the vibrating table and a spindle integral with the body and extending perpendicularly to the body and to the vibration plane of said vibrating table.

5. The device according to claim 4, wherein said notches are formed at the free end of the spindle.

6. The device according to claim 5, wherein said free end of the spindle is conical in shape.

7. The device according to claim 1, wherein said device comprises an air ejector for ejecting the separated balance springs when the vibrating table is caused to vibrate.

8. The device according to claim 7, wherein said device comprises a collection tray to receive the ejected balance springs.

9. The device according to claim 5, wherein said device comprises a removable cover configured to at least partially cover the free end of the spindle.

10. The device according to claim 9, wherein said removable cover is movable between a closed position preventing the balance springs from being removed from the support and an open position allowing the assembly of wound in balance springs to be inserted onto the support and allowing the balance springs separated from the support to be removed.

11. The device according to claim 10, wherein said removable cover can be moved translatably along an axis perpendicular to the vibration plane of the vibrating table.

12. The device according to claim 10, wherein said removable cover comprises a recess configured to receive the free end of the spindle when it is in the closed position.

13. The device according to claim 1, wherein said device comprises a motor configured to cause the vibrating table to vibrate at a frequency of between 1,000 Hz and 12,000 Hz, preferably between 4,000 Hz and 8,000 Hz.

14. The device according to claim 13, wherein said motor is an air motor or a piezoelectric motor.

15. A method for manufacturing a balance spring intended to equip a balance of a horological movement, wherein the manufacturing method comprises a step of separating an assembly of wound in balance springs having undergone an expansion cycle, which step is carried out by implementing the separation device according to claim 1.

16. The method for manufacturing a balance spring intended to equip a balance of a horological movement, according to claim 15, wherein said method comprises, prior to the separation step, a winding in step consisting of winding a plurality of rolled wires in a barrel by means of a winding star so as to form the assembly of wound in balance springs.

17. The method for manufacturing a balance spring intended to equip a balance of a horological movement, according to claim 16, wherein said method comprises, after the winding in step, an expansion step for relieving the stresses in the assembly of wound in balance springs.

18. The method for manufacturing a balance spring intended to equip a balance of a horological movement, according to claim 15, wherein said balance spring is a compensating spring.

19. The method for manufacturing a balance spring intended to equip a balance of a horological movement, according to claim 18, wherein said balance spring is made of a niobium and titanium alloy.
